(19) United States
(12) Patent Application Publication
(10) Pub. No.: US 2002/0123972 A1
(43) Pub. Date: Sep. 5, 2002

(54) Apparatus for and method of secure ATM debit card and credit card payment transactions via the internet

(76) Inventors: Robert B. Hodgson, Dunwoody, GA (US); Harry Hargens, Hampton, GA (US)

Correspondence Address: LOW HAUPTMAN GILMAN & BERNER, LLP, 1700 Diagonal Road, Suite 310, Alexandria, VA, 22314, US

(21) Appl. No.: 09/773,609

(22) Filed: Feb. 2, 2001

(51) Int. Cl. G06F 17/60

(52) U.S. Cl. 705/72; 705/43; 713/153

(57) ABSTRACT

The present invention is directed to a combination software and/or hardware system that provides consumers with a secure method for making and accepting credit card and ATM card payments over the Internet. A Data Encryption Standard (DES) encrypted Personal Identification Number (PIN) Block is created at the consumer's Internet access device meeting of American National Standards Institute (ANSI) X9.8 and Automatic Teller Machine (ATM) network requirements. The PIN block and card information are in a public key/private key encrypted financial payment transaction data block using additional layer(s) of encryption also performed at the consumer's Internet access device. The FP block is transmitted to an STMS for the generation of a financial transaction request that is sent to the payment processor according to the implementation method chosen by the system software at the payment processor. The FP block is decrypted at the STMS using a decryption algorithm matching that used by the software at the consumer's Internet access device. The encrypted PIN block within this data will be translated by the HSM dependent upon the processor that the transaction is to be routed to. The data is then re-formatted for transmission to the appropriate transaction processing network, and subsequently forwarded to the appropriate payment service processor accordingly. The present invention is independent of the encryption algorithm(s) used, and may be implemented with any number of encryption algorithms.

### FIELD OF THE INVENTION

The present invention relates generally to the field of secure communications, and more particularly, to the field of secure transactions using the Internet. Even more particularly, the present invention relates to a method and apparatus for conducting a secure payment transaction on the Internet without providing a consumer's card information or other sensitive data to the merchant. The present invention is applicable to all types of cards and accounts (including ATM Cards, debit cards and credit cards), and can provide secure payment transactions with each of these cards using the Internet. While the present invention has initially been used to secure payment transactions via the Internet, it could also be used to provide secure access to other types of data or transactions such as banking services that are accomplished via the Internet.

### BACKGROUND OF THE INVENTION

There is much concern about the security of financial transactions using the Internet. While the Internet is very useful for browsing for information, many are quite hesitant to send their credit card information because there is a significant risk that the information can be intercepted on the Internet and stolen. The consumer fear associated with transmitting credit card information via the Internet has been an impediment to the growth of eCommerce.

Another impediment to the growth of eCommerce has been the lack of ANY commercial system offering consumers the option of using their ATM-Card with a PIN over the Internet. Many consumers do not have or prefer not to use credit cards but do have an ATM Card; these consumers have been blocked from using the Internet to make purchases because their PIN numbers can be intercepted and stolen.

One way to avoid the problems of the Internet is not to use it at all, however, this means that the benefits of the Internet cannot be realized.

One proposed solution to this problem is described in U.S. Pat. No. 5,809,143 issued on Sep. 15, 1998. Apparatus and methods are disclosed in the ′143 patent for transacting secure purchase and bill payment transactions. The method for transacting a secure purchase via an Internet uses a system including a computer, a first communication device coupled to the computer and to the Internet, and a secure keyboard, the secure keyboard including a controller, an interface between the controller and the computer, a removable media interface, an alphanumeric keypad, an encryption device, and a second communication device coupled to a secure host via a second phone line. The method using the disclosed system includes the steps of browsing the Internet via the first communication device, and retrieving item data for a purchase from the Internet via the first communication device, and accessing information from removable media using the removable media interface. The information includes a user identifier and an issuer identifier, and a PIN entered on the alphanumeric keypad. The PIN is encrypted using the encryption device and sent to the secure host via the second communication device along with the information, the item data, and the encrypted PIN. The secure host blocks the information and the PIN from access by others on the Internet. The secure host requests authorization from a bank system for making the purchase using the information and PIN and proceeds with the purchase if the secure host receives from the bank system a bank authorization for the purchase. Otherwise the secure host cancels the purchase. The secure host sends purchase transaction data to the secure keyboard via the second communication device. The secure keyboard then prints a purchase transaction receipt.

Disadvantageously, by definition, the “secure keyboard” disclosed in the ′143 patent relies on the use of a second phone line to route transaction data securely around the Internet, rather than over the Internet. This approach is appropriate for securing sensitive data in commercial and military applications, however, the burden for a second line (in terms of both the ongoing cost and the initial installation complexity) is onerous and unacceptable to most consumers. Further, the approach of routing the transaction data over a second path, and merging it later back at the merchant's web site, adds an unacceptable level of difficulty to the implementation for merchants.

Another disadvantage is that the “secure keyboard” requires a modem, printer and card reader integrated into a keyboard. This results in a very expensive device, that needlessly replicates hardware already present in a computer and therefore this is also impractical from a cost/market viewpoint.

Some commercial systems (e.g. CyberCash) use a different type of system, which keeps the consumer's credit card information on a central database and use an encrypted certificate to reference that credit card information and build the transaction for the payment processors. This is a purely software encryption method and relies on the database at CyberCash to be secure from hacking. Such systems have a strong disadvantage; any encryption scheme that relies solely on software to secure data when it is sent via the Internet can be defeated by a virus that “sniffs” the data entered at the consumer's keyboard, before it can be encrypted. This weakness exists even in systems where the data is only sent once, for storage at a central site.

A disadvantage of all the systems described above is that any system that stores many card numbers in a central site is vulnerable to assault via the Internet. Thus, hackers can steal large blocks of card information from such sites, as has been reported in the press many times in the past 18 months, including cases such as CD Universe, Western Union, and CreditCards.com; in each case, tens of thousands of credit card numbers were stolen by professional criminals.

American Express (AMEX) and others have announced systems that employ a “One time use” card number, or “pseudo-card-number”. In these systems, the consumer must acquire a new pseudo-card-number for each transaction. Disadvantageously, this approach is clearly inconvenient for the consumer, as well as interfering with much of the credit card payment infrastructure that is already in place world-wide.. For example, pseudo-cards present a problem for the Amazon.com quick payment system that keeps the consumer's credit card information to build the payment transactions. The Pseudo number is different each time so the Amazon model will no longer work. Pseudo-cards also present multiple problems for Visa and MasterCard, such as the fact that back office systems rely on the consumer's card number to handle disputes between consumers and merchants.

Another proposed method of performing an on-line ATM/POS transaction over a public access network is disclosed in U.S. Pat. No. 6,098,053. In this patent, a method of performing a financial transaction between a purchaser and a merchant comprises creating purchaser payment instructions including encrypted, electronic representations of a purchaser transaction amount, card information and security information. The card information identifies the checking or savings account at a purchaser's bank and the security information comprises a personal identification number associated with the identified card for authorizing its use in an on-line ATM/POS transaction. Card information and the security information must be encrypted, using an encryption method dictated by on-line ATM/POS transaction systems standards. The purchaser payment instructions are protected by an encryption or digital signature. The digital signature of the purchaser provides verification of the identity of the purchaser and the integrity of the purchaser payment instructions. The purchaser payment instructions are electronically delivered to the merchant, over a public access network such as the Internet. Merchant payment instructions are appended to the purchaser payment instructions to create financial transaction instructions. The merchant payment instructions comprise merchant identification and merchant deposit account identification used in performing the transaction. The financial transaction instructions are protected by encryption and/or by the digital signature of the merchant. The merchant's digital signature provides verification of the merchant's identity and of the integrity of the financial transaction instructions. A digital certificate of the merchant may be appended to the financial transaction instructions, where the merchant's digital certificate provides additional verification of the merchant's identity and the integrity of the financial transaction instructions. Disadvantageously, credit card information is provided in encrypted form to the merchant. By sending this information to the merchant, there is potential for a security breach. An additional large disadvantage is the enormous difficulty and cost of implementing such a system; This system requires that a digital certificate be provided to each consumer by their card issuer (their bank, AMEX, etc.) and that all processors in the transaction process must make significant changes to their systems.

A need continues to exist in the art for a method and apparatus in which an ATM card transaction, or a credit card transaction being conducted over the Internet can be initiated by a consumer and the card information and PIN can be securely sent to a transaction processor, without sending the card information or PIN to or through the merchant, without requiring massive changes to existing payment system infrastructures, and without requiring the mass issuance of a new identification method (such as a digital signature or digital certificate) to consumers.

### SUMMARY OF THE INVENTION

It is, therefore, an object of the invention to conduct secure Internet transactions over the Internet using simplified commercially available off the shelf hardware.

Another object of the present invention is to conduct secure Internet transactions over the Internet using a single phone line.

Yet another object of the present invention is to provide a method and system of software loaded onto a consumer computer, merchant server and a centralized secure transaction management server that allows a consumer to conduct secure Internet transactions over the Internet.

It is yet a further object of the present invention to encrypt a PIN and credit card or ATM card information for transmission over the Internet using DES and public/private key encryption.

Yet a further object of the present invention is to provide a secure method of transacting a credit card or ATM card purchase transaction with a merchant on the Internet without sending a card number or PIN to the merchant.

Still a further object of the present invention is to provide a method and apparatus for securely routing a credit card or ATM card Internet payment transaction to multiple payment processors.

Another object of the present invention is to provide triple DES encryption of payment data over a security zone between a security module and the PIN/PAD.

Another object of the present invention is to provide an encrypted value (such as a MAC) to verify that none of the parties alter the transaction during the process.

Another object of the present invention is to provide a method and system that provides secure Internet transactions while minimizing or eliminating changes required by the banks and processors to enable such transactions.

It is yet another object of the present invention to use a PIN/PAD or other hardware device to enter and encrypt a consumer PIN or other means of identification, such as biometric data.

It is yet another object of the present invention to accomplish the same security and benefits provided by a physical data terminal such as integral card readers and PIN pads used by “brick and mortar” merchants through a system and process that “distributes” the traditional terminal's functionality across software located at a merchant's Internet server/web site, a consumer's PC/browser, and a Secure Transaction Management System (STMS), and an optional hardware security device interfaced to the consumer's PC/browser.

It is yet another object of the present invention to make credit card transactions more secure even in the case where no PIN pad/card reader is attached to the consumer's PC and therefore the card data must be keyed into the consumer's keyboard as it is today. Although the preferred embodiment as described herein uses a hardware device at the consumers PC to provide secure data entry and encryption, some incremental security is provided even if a PIN/PAD or card reader is not used.

The present invention is directed to a novel process that combines software and hardware to provide consumers and merchants with a secure method for making and accepting credit card and ATM card payments over the Internet. Using various software and/or hardware implementations, the system operates by:

1) In the case of ATM-Card transactions, creating (in secure hardware such as a PIN/PAD attached to or incorporated into the consumer's Internet access device) a Data Encryption Standard (DES) encrypted Personal Identification Number (PIN) Block meeting American National Standards Institute (ANSI) X9.8 and Automatic Teller Machine (ATM) network requirements (as a result of the consumer entering their PIN number and encryption automatically taking place in the PIN/PAD);

2) In the case of both ATM-Card and credit card transactions, optionally using such PIN pad hardware to read the magnetic stripe on the back of the card, and include the magnetic stripe data and PIN block in a larger encrypted block created using an algorithm known as “triple DES” (also referred to below as a “PIN block”).

3) Using additional layer(s) of encryption (performed by the consumer's Internet access device) to place the PIN block, card information, dollar amount, merchant identification number, and any other needed data in a public key/private key encrypted financial payment transaction data block (“FP Block”).

4) Transmitting the FP block to a “Secure Transaction Management Server” (STMS), for the generation of a financial transaction request that is sent to the payment processor according to the implementation method chosen by the system software at the payment processor.

5) The FP Block is decrypted at the STMS using decryption algorithm(s) matching that used by the software at the consumer's Internet access device. The encrypted PIN block within this data will be translated (deencrypted and re-encrypted) by a Hardware Security Module (HSM);

using for the re-encryption the appropriate DES encryption key for the transaction processor that the transaction is to be routed to. The data is then re-formatted for transmission to the appropriate processor, to then be handled as traditional transactions are today. The present invention is independent of the encryption algorithm(s) used, and may be implemented with any number of encryption algorithms. The enhanced security provided by the present invention is also independent of the means used to verify the user's identity, and hardware devices such as fingerprint scanners, retina scanners, etc., could be used in place of entering a secret number (PIN) into an encryption device (PIN/PAD).

The encrypted PIN block remains encrypted until reaching the payment processor where existing DES encryption hardware decrypts the PIN block. The encryption of the PIN block at the consumer's location may be done either by hardware or by software executed by the Internet access device although current regulations at many ATM networks require hardware encryption. In the case of hardware, the present invention covers both hardware attached as a peripheral or add-on, and hardware incorporated into the original design and/or manufacture of the device. The transaction is then processed using the existing credit card or ATM POS (Point Of Sale) transaction processing functions.

These and other objects of the present invention are achieved by a method of transacting a secure transaction via the Internet while browsing a merchant web site by a user. After the consumer has filled their shopping cart in the normal manner, a secure payment as described herein is initiated when the consumer clicks the appropriate button on the merchant web site. A script is sent from the merchant web site to the consumer's browser. The script, executing on the consumer's browser, creates screens that prompt the consumer through swiping their card and entering their PIN on the PIN pad. An encrypted PIN block is created. An FP data block is built from data from the merchant web site including the Merchant ID, Processor Routing, Transaction amount and data from the consumer including the card data and the encrypted PIN block to form a data block. The encrypted payment block is forwarded to a secure host. A decrypted payment block formatted for use by a bank system is routed. The authorization is forwarded to the merchant web site. An indication is sent of a completion of the purchase to the user.

The foregoing and other objects of the present invention are achieved by a method of transacting a secure ATM transaction via the Internet. A merchant web site is browsed by a user. A secure payment transaction is initiated at the merchant web site prompting a consumer through the process of entering payment data. An encrypted PIN block is created. An encrypted payment block is built at the consumer's Internet access device that includes the encrypted PIN block and the payment data enclosed in two or more layers of encryption. The encrypted payment block is forwarded to a secure host without sending the encrypted payment block to the merchant web site. The payment block is decrypted at the secure host. The decrypted payment block is routed to a payment processor to request authorization for the payment transaction. If the payment processor sends an authorization for the payment transaction, then the authorization is forwarded to the consumer and the merchant.

The foregoing and other objects of the present invention are achieved by a method of transacting a secure credit card payment transaction via the Internet. A merchant web site is browsed by a user. A secure payment transaction is initiated at the merchant web site prompting a consumer through the process of entering payment data. A credit card number is entered. An encrypted payment block is built at the consumer's Internet access device that includes the credit card number enclosed in three or more layers of encryption. The encrypted payment block is forwarded to a secure host without sending the encrypted payment block to the merchant web site. The payment block is decrypted at the secure host. The decrypted payment block is routed to a payment processor to request authorization for the payment transaction. If the payment processor sends an authorization for the payment transaction, then the authorization is forwarded to the consumer and the merchant.

The foregoing other objects of the present invention are achieved by a method of transacting a secure transaction via the Internet. A PIN/PAD is operatively connected to the consumer Internet access device for entering a consumer PIN and creating an encrypted PIN block. A consumer Internet access device has a consumer software plugin associated with a web browser residing thereon for building an order including the encrypted PIN block and transaction data enclosed in two or more layers of encryption to form an encrypted payment block. A merchant server has a merchant response software residing thereon for building an encrypted HTML payment page including an encrypted MAC. A secure transaction management server has software residing thereon and a hardware security module for decrypting the encrypted payment block to be forwarded to a payment processor.

The user of the words “merchant” and “shopping” are meant to be descriptive and not limiting. The present invention is equally applicable to securing transactions for shopping, bill paying, banking transactions, etc., in business-to-consumer (B2C), business-to-business (B2B) and personal payments (P2P) situations.

The foregoing and other objects of the present invention are achieved by a system for transacting a secure payment via the Internet including a consumer Internet access device having a software plug-in loaded into a web browser residing thereon for building a secure payment message. A PIN/PAD is operatively connected to the consumer Internet access device for entering and encrypting a consumer PIN. A merchant server has a software residing thereon for communicating with the software at the consumer's Internet access device to initiate the secure payment process. A STMS has a software residing thereon for securely receiving the payment messages created by the software at the consumer's Internet access device, forwarding the message to a bank system to obtain an approval, and forwarding the authorization from the bank system back to the merchant server and the consumer Internet access device.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of the secure Internet payment transaction system for ATM transactions according to the present invention including a security zone between a PIN/PAD connected to a consumer PC and a secure transaction management system;

FIG. 1A is a flow diagram similar to FIG. 1 for secure credit card transactions and ATM debit cards according to the present invention;

FIGS. 2A, 2B and 2C are high level flow diagrams of the process according to the present invention;

FIG. 3 is a high flow diagram depicting some of the steps in FIG. 2 in greater detail;

FIGS. 4A-4B are flow diagrams depicting some of the steps in FIG. 3 in greater detail;

FIG. 5 is an illustration of a prepare to authorize screen;

FIG. 6 is an illustration of the selection of an ATM card or credit card using a prepare to authorize screen;

FIG. 7 is an illustration of a screen which asks the user to swipe their card through the PIN/PAD;

FIG. 8 is an illustration showing the current status confirm transactions;

FIG. 9 is an illustration of a transmitting, do not interrupt screen;

FIG. 10 is an illustration of a transaction complete screen;

FIG. 11 is a high level block diagram of a computer system usable with the present invention; and

FIG. 12 is a high level block diagram according to the present invention of security zones in a multi-processor environment.

### BEST MODE FOR CARRYING OUT THE INVENTION

A method and apparatus for secure ATM debit card and credit card payment transactions via the Internet according to the present invention are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

There are various shopping cart systems in use on the Internet. The present invention may be implemented with any of these. Regardless of which shopping cart system is used, when the consumer is ready to complete their purchase by paying for the items in their shopping cart the process for the financial transaction will be the same.

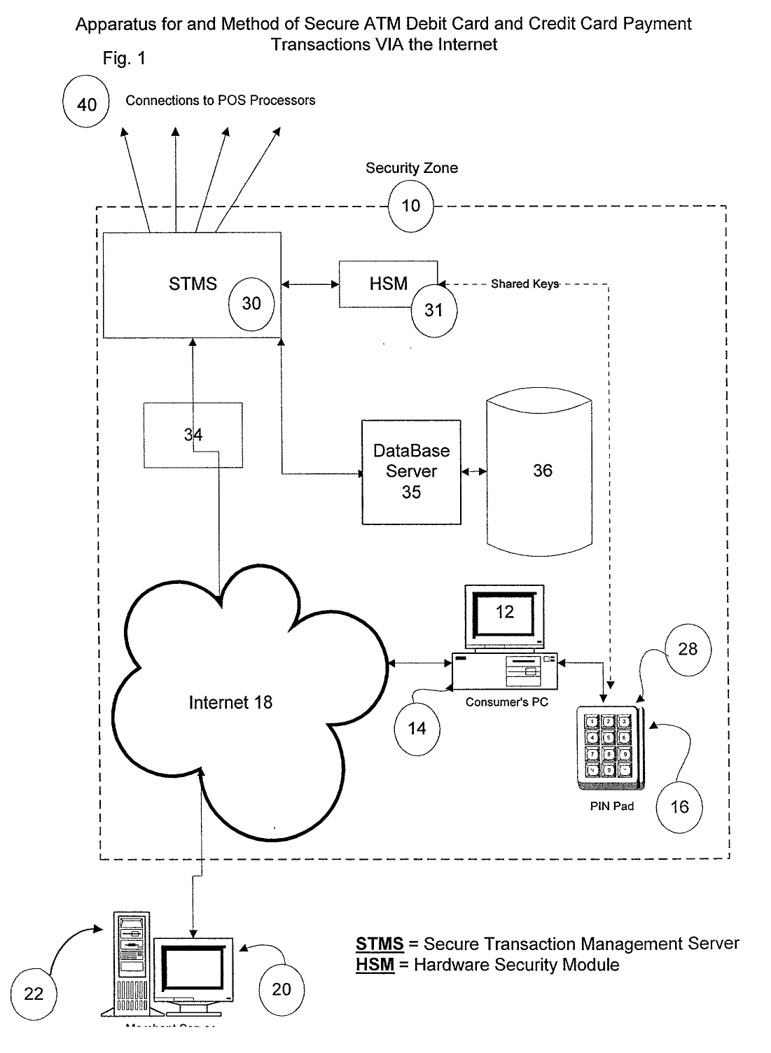

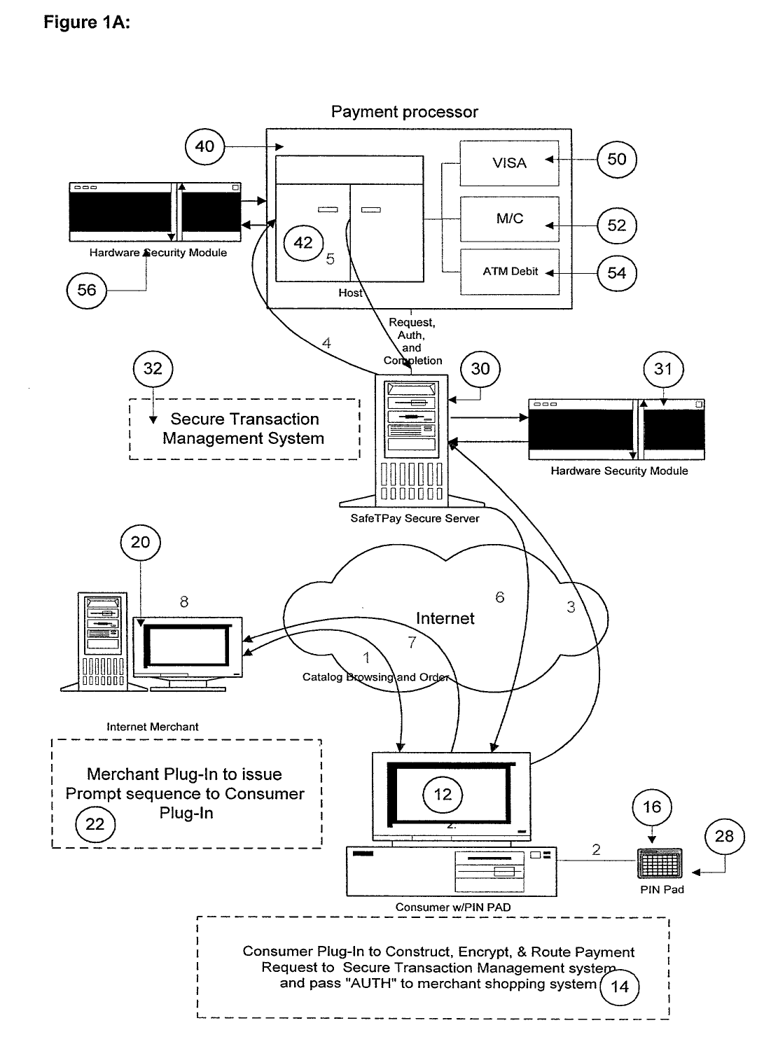

Refer now to FIG. 1 where the physical and logical architecture of the present invention is depicted. A security zone 10 includes a consumer personal computer 12 having a consumer plug-in software 14 that is loaded into the consumer's PC 12 to drive the PIN/PAD hardware 16 that is interfaced to PC 12. The security zone 10 extends from the PIN/PAD 16 to a hardware security module (HSM) 31 attached to a Secure Transaction Management Server (STMS) 30.

As used herein, the term security zone refers to that portion of a communication system that is located between two devices that use hardware encryption to protect messages passed between them, i.e. passed from one end of that zone to the other end. In this case, the two devices may be either a PIN/PAD and a hardware security module (HSM), or two HSMs. In either case, the two devices that constitute a zone share a set of keys used to encrypt and decrypt messages. The correct key(s) must be loaded in each device, for it to be able to decrypt messages encrypted by the device at the other end of the zone. HSMs are capable of supporting multiple keys, so that they can be the endpoint 15 of one zone and the beginning of another.

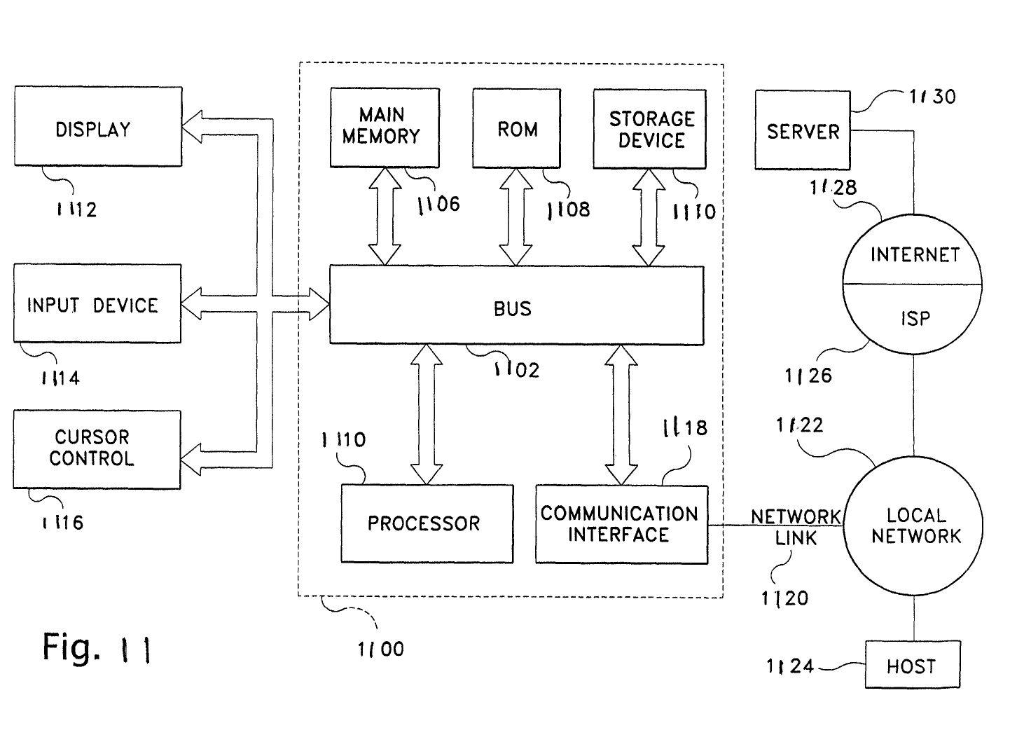

As illustrated in FIG. 1, the security zone is within the large-dashed lines surrounding the system, and the key sharing is depicted with finely dashed lines between the PIN/PAD 16 and the HSM 31. The PIN/PAD 16 is used to conduct secure financial transaction for credit cards and/or debit cards. In a typical financial transaction, information is read from a credit or debit card and then the consumer enters certain information via the PIN/PAD 16 using number keypad 28. An important data entered by the user is the user's PIN number. The PIN is assigned to the user by a financial institution and needs to be kept secure. Today, PINs are in common use with ATM credit cards. Even though a user may be able to select his/her own PIN, the PIN should be known only to the user and the financial institution. Optionally, as part of computer system 1100 (see FIG. 11) or the PIN/PAD 16, a magnetic card reader can be provided. In the preferred embodiment illustrated herein, the card reader is included in the PIN/PAD 16, so that the encryption capability of the PIN/PAD 16 may be applied to the cards magnetic stripe data. Although the aforementioned devices fall into the category of biometric devices, other security devices such as smart cards can also be incorporated. Alternatively, other hardware devices such as fingerprint scanners, retina scanners, etc., could be used in place of entering a secret PIN into an encryption device (PIN/PAD).

The consumer software plug-in 14 is installed on the consumer PC 12 and allows for the PIN/PAD 16 to be activated from the consumer's web browser during a secure transaction. The plug-in 14 also has added security and encryption routines that enable RSA and SSL encryption to be applied to secure payment messages (“FP Blocks”, defined below) that are sent from within the browser. The consumer PC 12 is connected to the Internet 18.

Outside of the security zone 10 is a merchant server 20. The Internet merchant server 20 has a Secure Transaction System Merchant Framework (STS-MF) 22, which is an HTML extension to the merchant's existing shopping cart software that resides on the merchants+ web server 20. The merchants+ web server 20 includes web pages for browsing by the consumer 12. The merchant server 20 is connected to the Internet 18.

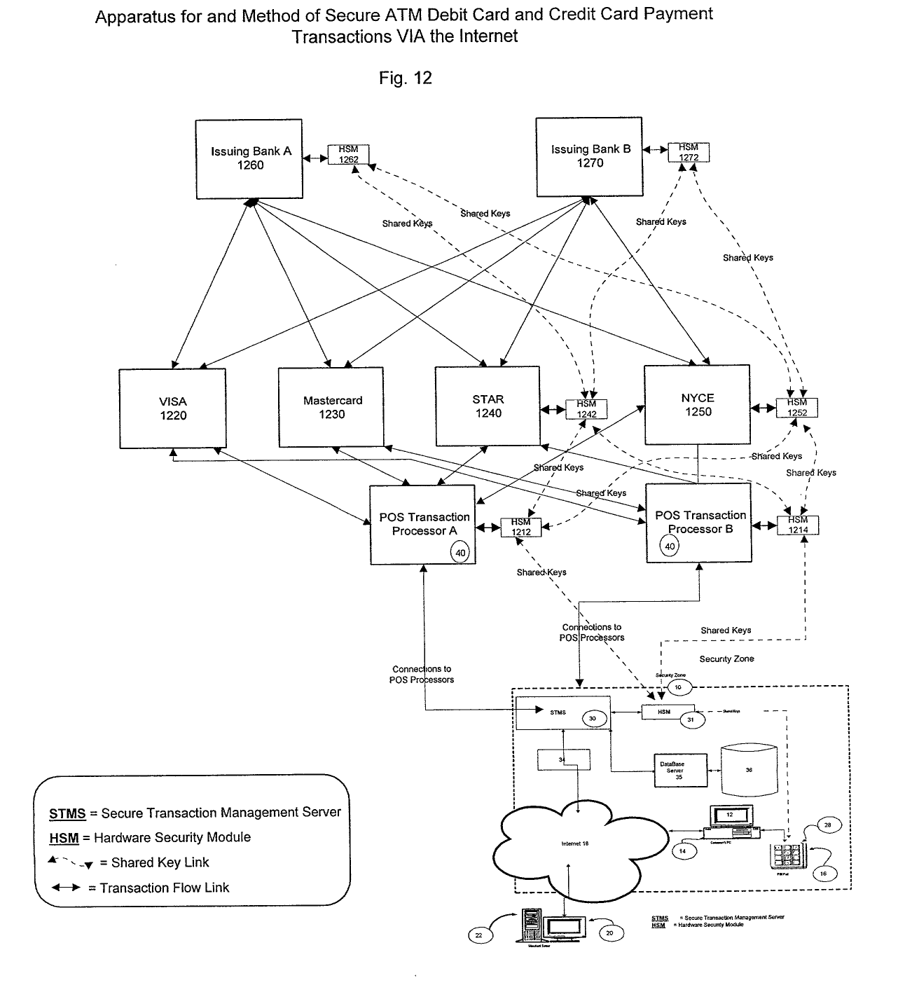

A secure transaction management server 30 handles all of the payment transaction requests (such as for purchases or bill payments by a consumer using consumer PC 12) over the Internet 18. A secure transaction management software STMS 32 resides on the secure transaction manager server 30. A firewall 34 is located between the STMS 30 and the Internet 18. An STMS database 36 is connected to the STMS 30. All payment transactions are forwarded from the STMS 30 to a POS transaction processor 40. The POS transaction processor 40 can be a third party such as UPPS, FDC or National Data Corporation. The POS transaction processor 40 has an HSM 42 (see FIG. 12) which can decrypt data sent by the HSM 31 attached to the STMS 30.

The STMS 30 determines the correct POS processor 40 to which the transaction request should be sent which is the POS processor used by the bank that provides ATMCard and Visa/MC services to the merchant. The POS transaction processor 40 has an HSM from the HSM 31. By providing a means to send the transaction request from the consumer PC 12 to the POS processor 40, the STMS 30 eliminates the need to send sensitive information such as card information and PIN data to the merchant 20. Advantageously, the STMS 30 does send the needed credit card/debit card/smart card information to POS transaction processor 40 to request approval for financial transactions.

The present invention is described herein for one merchant and one consumer for convenience and it is to be understood that any number of merchants and consumers concurrently can utilize the present invention. Also for simplicity sake, FIG. 1 deals with only one POS processor, whereas in fact that STMS 30 might be connected to many POS processors 40 which are in turn connected to many issuing banks. Also for simplicity, several layers of existing infrastructure that may exist between the POS processor(s) and the card issuing bank(s) are not described herein.

The present invention uses three software components, collectively called a Secure Transaction System (STS), distributed across three computers; including the consumer PC 12 where the consumer plug-in 14 resides, the merchant server 20 where the “merchant plug-in” or “merchant framework” (STS-MF) 22 resides, and the STMS 30 where the secure transaction management software 32 resides.

A brief overview of the process that occurs within security zone 10 according to the present invention using the described architecture is illustrated in FIG. 1A. Refer specifically to FIG. 1A which illustrates a transaction flow sequence according to the present invention. As illustrated in FIG. 1A, there are numbered arrows which are used to explain the flow sequence. The consumer browses the merchant web site to select merchandise and initiate a transaction. Within arrow 1), the following steps are performed:

1a) An HTML payment page is built at the merchant site 20 in the plug-in 22.

1b) A Message Authentication Code (MAC) field is generated, encrypted and hidden in the HTML payment page.

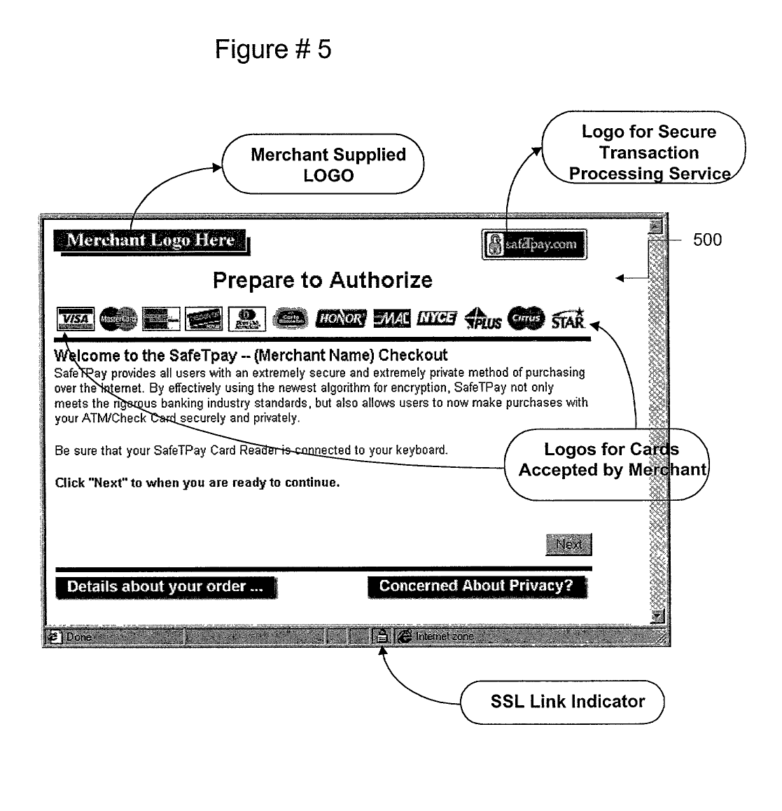

1c) An HTML page is sent to consumer's PC 12 (see FIG. 5).

Within arrow 2), the browser script contained in HTML payment pages presents a series of prompts to the consumer, viewing a monitor 1112 and walking the consumer through the process of building the secure message, as described below. Within arrow 2), the following steps are performed:

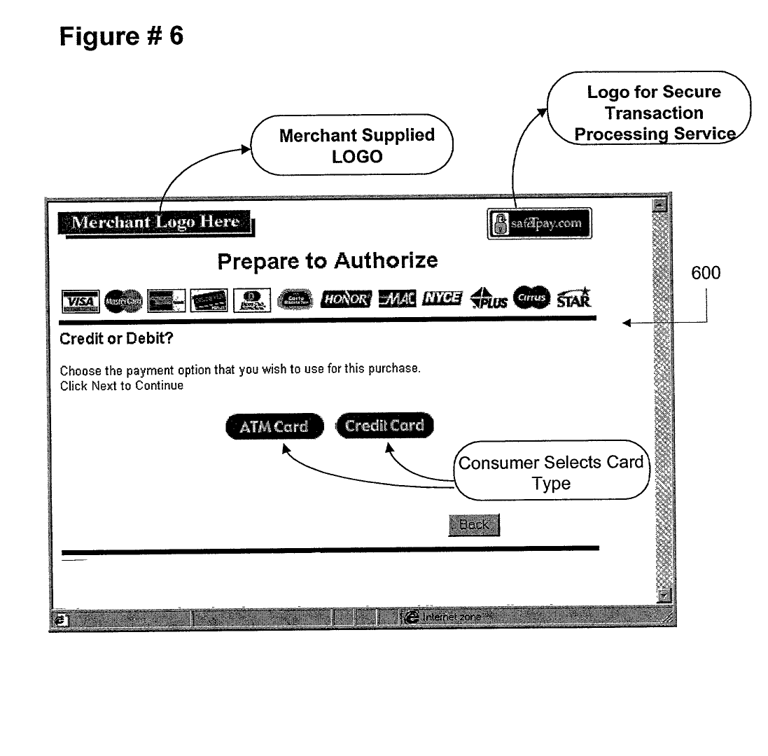

2a) A consumer chooses “credit” or “debit” (see FIG. 6).

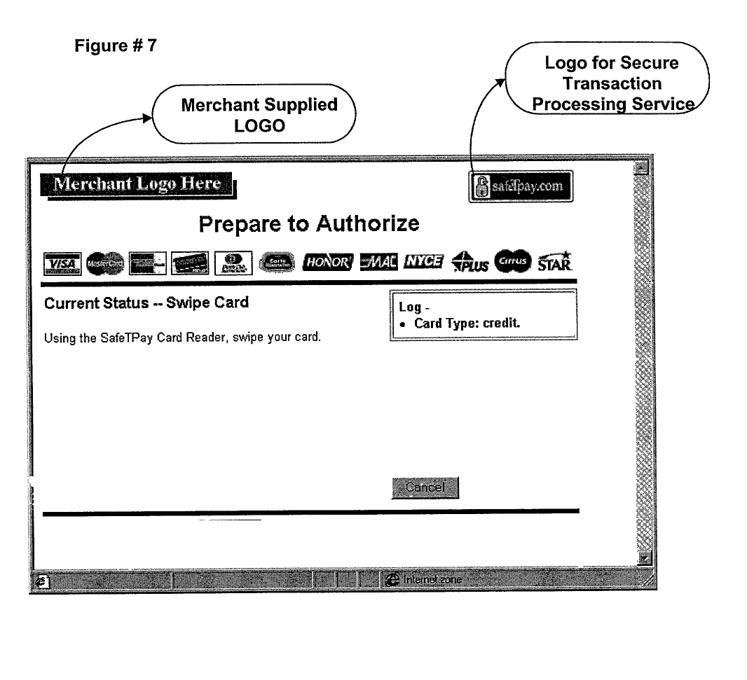

2b) A consumer swipes card (see FIG. 7). Card data is optionally encrypted by the PIN/PAD 16 and the encrypted data block is passed to the PC 12, so that card data is never “in the clear”.

2c) If “debit” selected, the consumer is prompted and enters a PIN in the secure PIN/PAD 16.

2d) PIN/PAD 16 building the secure PIN block using DES or ATM network standards, then passes the PIN block to PC 12. The PIN number is never “in the clear”.

2e) In consumer's PC, the PC software combines the card data, PIN block, dollar amount, Merchant ID, MAC, etc., into a complete outbound message (FP Block) and encrypts this entire data block with RSA (public key) encryption, as specified by SET.

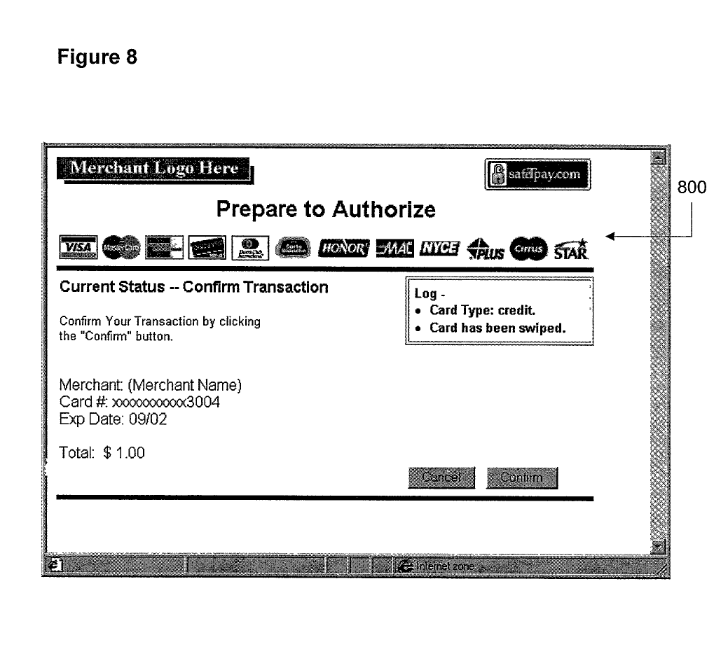

2f) A consumer is asked to confirm the transaction (see FIG. 8).

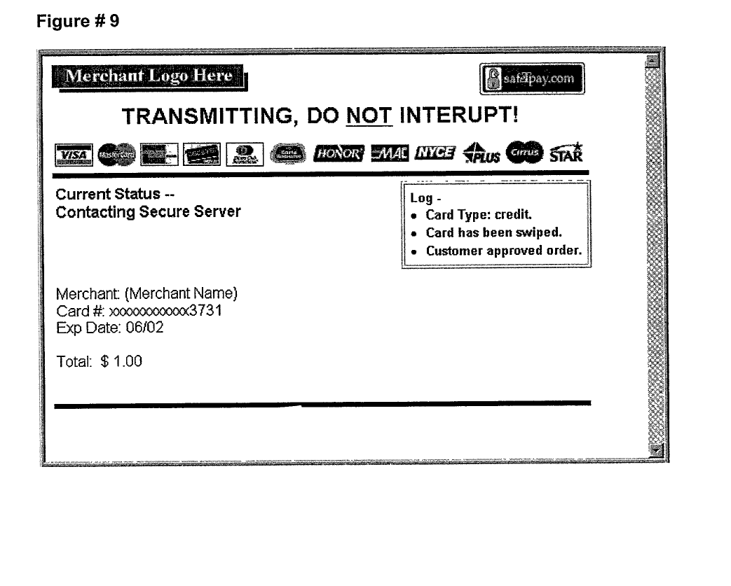

At arrow 3), software causes the browser to further encrypt the message with 128bit SSL and transmit it directly to STMS 30 (see FIG. 9). Advantageously, no consumer payment data is sent to the merchant.

At arrow 4) the STMS 30 performs the following steps:

4a) Decrypts (removes) the SSL and RSA layers.

4b) Verifies that the financial transaction data has not been altered by decrypting the MAC and comparing the results with the appropriate data elements contained in the FP block.

4c) Reformats the data per the POS processor's 40 existing message formats and passes the transaction data to a bank processor. This may include decrypting and reencrypting the PIN block, using the keys for an outbound security zone (see FIG. 12), i.e., the connection to the appropriate POS processor; note that the STMS can be connected to and route transactions to multiple POS processors, each of which will be a separate security zone with its own unique DES encryption keys.

At arrow 5), the POS processor 40 obtains the card issuing Bank's “AUTH” response and passes it to the STMS 30.

At arrow 6), the STMS 30 performs the following steps:

6a) the MAC field is generated, encrypted and hidden in the “AUTH” response message.

6b) Forwards “AUTH” response to consumer's PC 12.

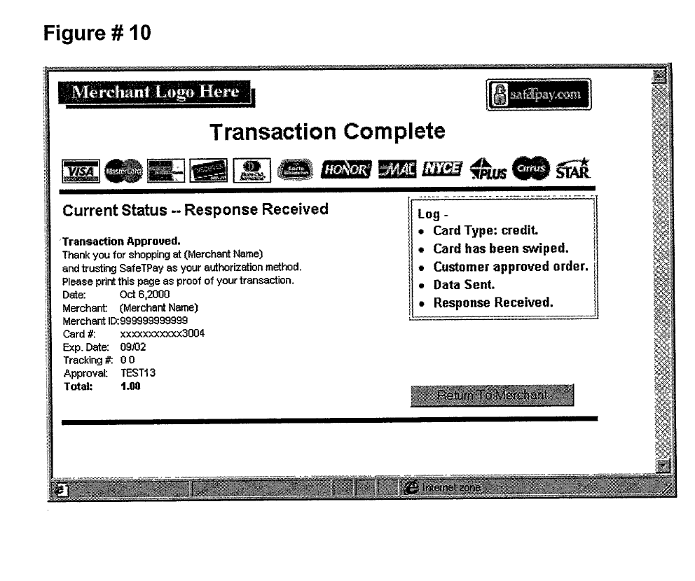

At arrow 7), the software at consumer's PC 12 displays the “AUTH” information to the consumer (see FIG. 10) and forwards the “AUTH” message to the merchant 20 with the MAC intact (not encrypted).

At arrow 8), the merchant plug-in 22 verifies that the financial transaction data has not been altered by decrypting the MAC and comparing the results with the appropriate data elements contained in the FP block.

The STMS 30 automatically sends a follow-up email to the email addressed used to register the PIN/PAD 16. The email contains the transaction information as a confirmation for the consumer.

The STMS 30 will generate a time-out reversal if it gets an indication that an Auth message could not be delivered. Given the nature of the Internet, it is difficult to guarantee delivery. That is why the email message is included as a “fail-safe” to alert the consumer whenever a transaction is completed.

In order to secure transactions from user modification prior to and after authorization, the following technique will be employed. The purchase amount passed to the client will be encrypted, using a proprietary encryption technique, along with the viewable amount visible to the client. When the client submits the merchant form to the STMS transaction server 30, the visible amount and the encrypted amount will be included in the data stream. This will permit verification of the amount at the STMS server 30 to insure that the client has not attempted to alter the amount. If the amount was altered, the client will be notified of the failure to complete the transaction and be given additional chances to cancel or try again. Once transaction authorization is completed, the success or failure of the transaction will be secured by encrypting the authorization code in the data stream back to the client. This data will be available to the merchant 20 depending on their technique used for processing. Once the merchant 20 receives the authorization response, it can be decrypted to verify the transaction status.

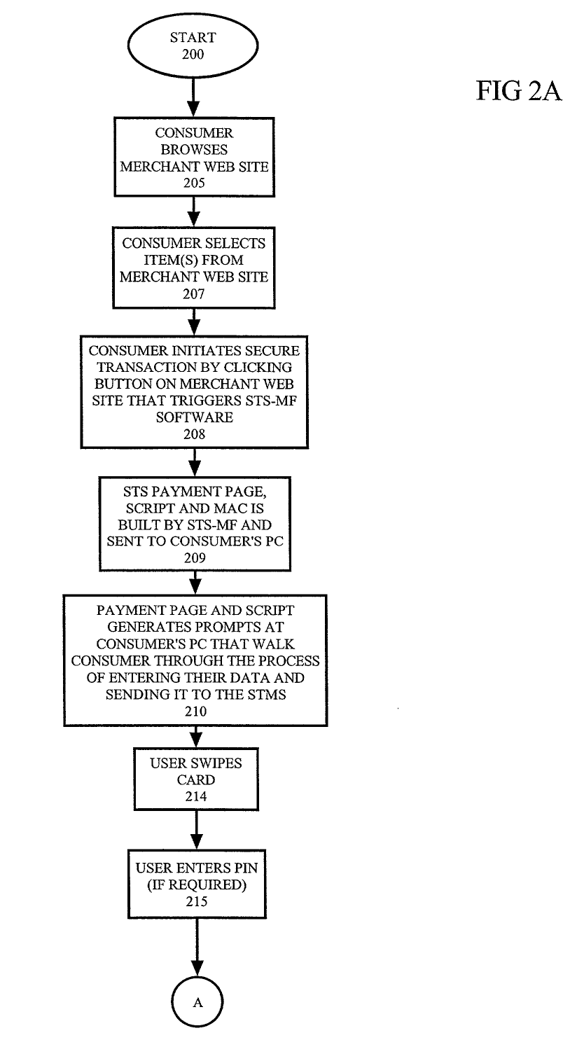

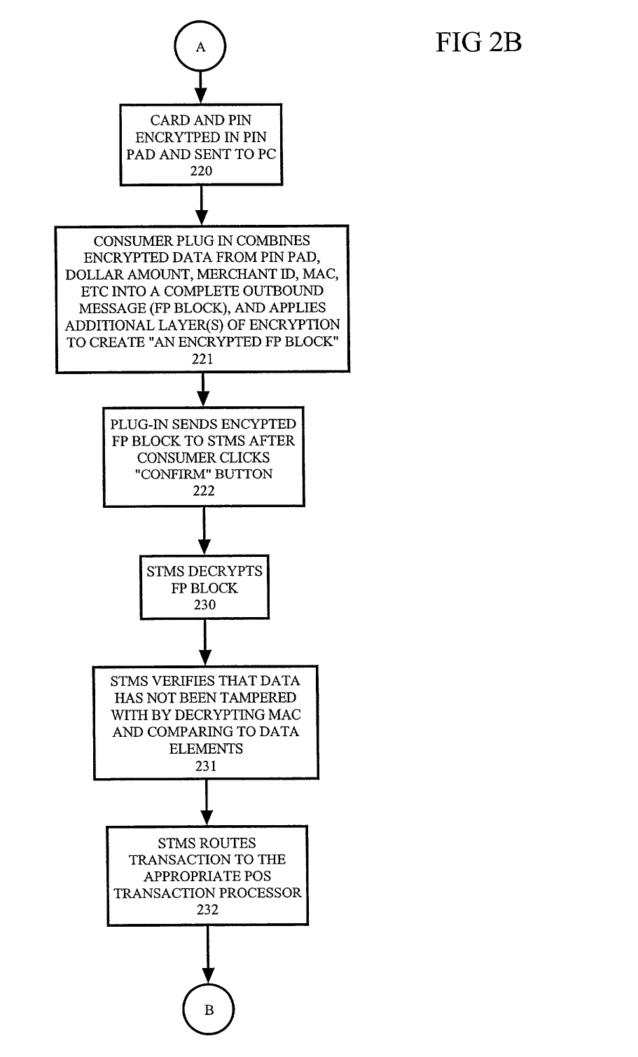

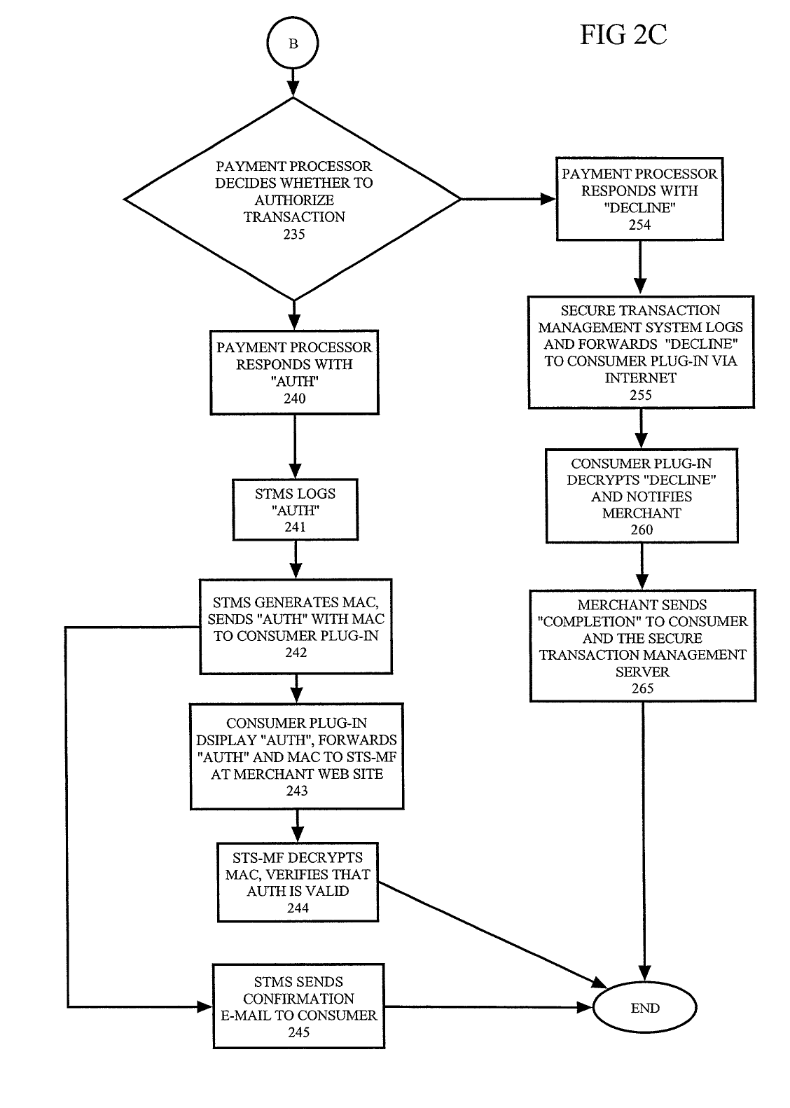

Refer now to FIGS. 2A through 2C. At step 200, the process is started. At step 205, the consumer using consumer PC 12 browses a merchant web site on the Internet merchant server 20 over the Internet 18. At step 207, the consumer using consumer PC 12 selects one or more items from the merchants+ Internet web site 20. When the consumer is finished shopping, he or she initiates a secure payment transaction at step 208 according to the present invention, by “clicking” on a button on the merchant's checkout page that triggers the STS-MF 22. At step 209, an HTML payment page is built at the merchant server 20 by the STS-MF 22 and sent to the consumer PC 12. A browser script contained in the HTML payment pages will present a series of prompts to the consumer at the consumer PC 12, as shown in FIGS. 5-10. These screens will walk the consumer through the process of building a secure message as described in detail herein. As part of the process of building the HTML page and script, a Message Authentication Code (MAC) is generated, encrypted and hidden in the HTML payment page shown in FIG. 5. This will be used later to verify that the transaction amount was not altered after the HTML page and script is sent from the merchant web site 20. Other encryption or hash routines might be used for the purpose of preventing subsequent alteration.

A message authentication code (MAC) is defined as a bit string that is a function of both data (either plaintext or ciphertext) and a secret key, and that is attached to the data is order to allow data authentication. The function used to generate the message authentication code must be a one-way function. The data associated with an authenticated message allowing a receiver to verify the integrity of the message.

After the MAC is generated, the HTML page (FIG. 5) is sent to the consumer PC 12. At step 210, the payment page and script begin the process of prompting the consumer through the transaction. After the consumer clicks on the “Next” button shown on FIG. 5, they are presented with the screen shown on FIG. 6, which prompts them to choose a payment type, such as credit card or debit card. Then in step 214, after clicking on a payment type, the user is prompted via the screen shown in FIG. 7 to swipe the credit or debit card via the PIN/PAD 16. Optionally the system may support manual entry of a credit card number, if the card reader is broken or not present or if the card is damaged; and other identification methods such as fingerprint and retina scan can be supported by the invention, in place of or in addition to the PIN number in step 215. At step 220, card data is optionally and preferably encrypted by the PIN/PAD 16 and the encrypted data block is passed to the PC 12 so that the card data is never “in the clear.” Then a confirm transaction screen as shown in FIG. 8 is shown to the consumer and the consumer is prompted to confirm the transaction. After clicking the “confirm” button shown on FIG. 8 to proceed, the consumer is shown the screen in FIG. 9, which tells them that the transaction is in progress. After a response from the STMS is received at the consumer's PC, the consumer is shown the completion screen in FIG. 10.

At step 221, at the consumer's PC 12, the consumer plug-in module 14 combines the PIN block, dollar amount, merchant ID, MAC, etc. into a complete outbound message, and encrypts this entire data block with RSA (public key) encryption. The consumer plug-in 14 causes a web browser on the consumer PC 1200 to encrypt the message with 128-bit SSL and transmit the message directly to the STMS 30. Advantageously, no consumer payment data is sent to the merchant.

At step 222, when the consumer confirms their desire to proceed with the transaction by clicking the “confirm” button shown on FIG. 8, the consumer's PC 12 transmits the encrypted FP block to the STMS 30 and the screen in FIG. 9 is displayed to the consumer.

At step 230, the STMS 30 decrypts the SSL and RSA layers of the message sent by the consumer plug-in. At step 231, the STMS 30 verifies that the payment request has not been altered or tampered with by decrypting the MAC and comparing the results with the appropriate data elements stored in the secure transaction management system database 36. At step 232, the STMS 30 formats and sends the transaction request to the appropriate POS processor 40. Note that the STMS 30 can be connected to and route transactions to multiple POS processor 40, each of which will be a separate security zone with its own unique DES encryption key. The POS processor 40 then passes the transaction to the card-issuer for approval (“AUTH”) or decline. Note that there may be several intervening processors, networks, or card associations between the POS processor and the card issuer; this existing infrastructure is omitted from the text for simplicity.

At step 235, the issuing bank A checks to ensure that a proper credit card or debit card and PIN have been received and if the credit card or debit card and associated PIN is correct and the consumer's credit is satisfactory, then responds back to the POS processor 40 which in turn responds back to the STMS 30 with authorization to proceed with the transaction at step 240, or a decline at step 254.

If the issuing bank A or B decides not to authorize the payment, then at step 254, the POS processor 40 responds to the STMS with a decline. At step 255, STMS 30 logs the decline and forwards the decline to the consumer plug-in 14 via the Internet 18. At step 260, the consumer plug-in 14 decrypts the transaction and notifies the merchant 20 of the decline. At step 265, the merchant sends a “completion” to the consumer PC 12 and the secure transaction management server 30.

If the issuing bank responds with an “AUTH”, then at step 240 the POS processor 40 forwards this information to the secure transaction management server 30. At step 241, the STMS 30 logs the “AUTH” using the database server 36. At step 242, at the STMS 30, the MAC field is generated, encrypted and hidden in the Auth response message which is forwarded to the consumer plug-in 14 via the Internet 18. At step 243, the consumer plug-in 14 at consumer's PC 12 displays the Auth information (FIG. 10) to the consumer and forwards the Auth message to the merchant 20 with the MAC intact (not encrypted). At step 244, the merchant plug-in 22 verifies that the financial transaction data has not been altered by decrypting the MAC and comparing the results with the appropriate data elements stored in each of the three system components (STMS 30, consumer plug-in 14 and merchant framework 22). At step 250, the STMS 30 sends a follow-up e-mail to be the e-mail address used to register the PIN/PAD 16. The e-mail includes the transaction information as a confirmation for the consumer. The STMS 30 will generate a time-out reversal if it gets an indication that an AUTH message could not be delivered. Given the nature of the Internet, it is difficult to guarantee delivery. That is why the e-mail message is included as a “fail-safe” to alert the consumer whenever a transaction is completed. At step 252, the process is complete.

In order to secure transactions from user modification prior to and after authorization, the following technique is employed to create and verify the MAC defined above. The purchase amount is encrypted by the STS-MF 22 and used as a MAC that is sent in the message to the consumer plug-in 14. When the consumer plug-in 14 sends the transaction to the secure management transaction server 30, the visible amount and the encrypted amount will be included in the data stream (see FIG. 8). This will permit verification of the amount at the STMS 30 to ensure that the consumer has not attempted to alter the amount. If the amount was altered, the consumer will be notified of the failure to complete the transaction and be given additional chances to cancel or try again. Once the transaction authorization is completed, the success or failure of the transaction is secured by having the STMS 30 encrypt the authorization code in the data stream back to the consumer plug-in 14. Once the merchant 20 receives the authorization response, the MAC can be decrypted by the STS-MF 22 to verify the transaction status.

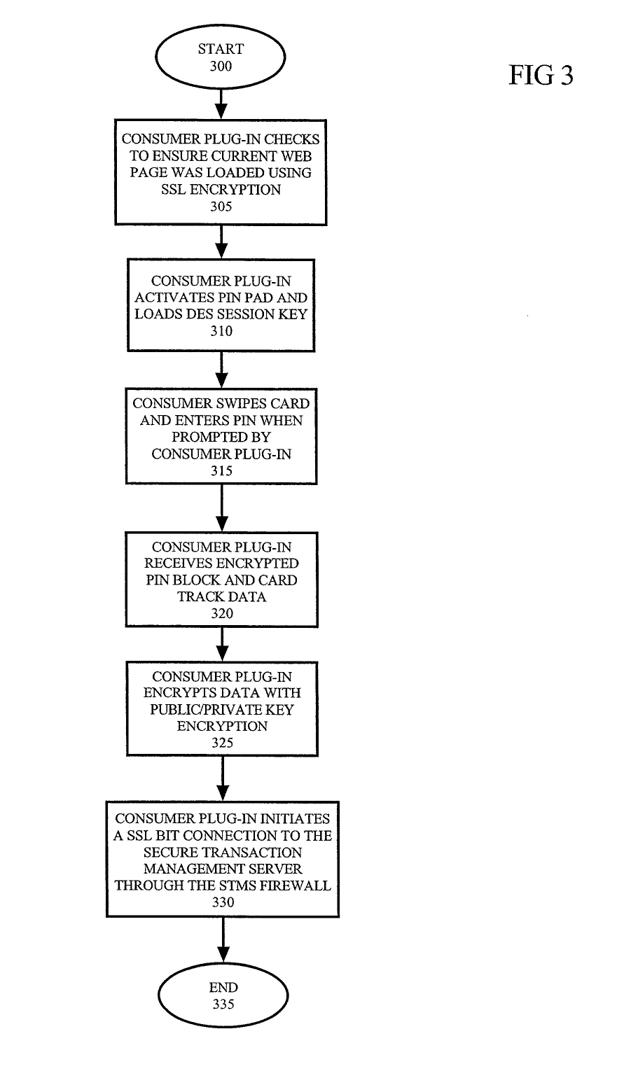

Steps 210, 214, 215, 220, 221 and 222 are described in greater detail in FIG. 3 where the process is started at step 300. At step 300, the consumer initiates the ATM or the credit card transaction and during step 305, the consumer plug-in 14 first checks to ensure that the current page was loaded using SSL 128 bit encryption. If SSL 128 bit encryption was not used, then the consumer plug-in 14 initiates an SSL session to the STMS 30 inserting a failure status message into a transaction log in the Secure Transaction Manager database 36. The STMS 30 then informs the consumer's PC 12 of the failure status. The consumer plug-in 14 also checks (if possible) whether the consumer has already registered their PIN/PAD 16 with the PC 12. At step 310, the consumer plug-in 14 initiates secure communication with the PIN/PAD 16 and loads a Data Encryption Standard (DES) session key. At step 315, the consumer plug-in 14 prompts the consumer for a debit or credit card and the consumer either enters their credit card number or swipes their debit or credit card. The consumer plug-in 14 presents a screen ensuring the consumer that the PIN is being encrypted. At step 320 the consumer plug-in 14 receives encrypted PIN block and card track II data which is magnetic stripe data from PIN/PAD 16 and at step 325, the consumer plug-in 14 then combines the encrypted data block from the PIN pad with the other transaction data (amount, merchant ID number, etc.) to build a Financial Payment (“FP”) data block, and then further encrypts the entire FP block. In theory any algorithm could be used; RSA public key encryption was chosen for the initial implementation.

Public key encryption is a solution to widespread open network security and is a more sophisticated form of code making, first developed by mathematicians at MIT in the 1970s. In this approach, each user creates two unique keys. For example, the consumer would have his/her “public key” which is published in a directory. The user has his/her own “private key”, which is kept secret. The two keys work together as a match set. Whatever data one of the keys “locks” only the other can unlock. For example, the consumer wants to send a private transaction. The consumer plug-in consumer plug-in 14 uses the “public key” to encrypt the transaction. When the secure server STMS 30 receives the transaction, the “private key” converts the encrypted message back to the original message.

Advantageously, even if a would-be criminal intercepts the transaction on its way to the STMS 30, there is no way of deciphering the transaction because the would be criminal does not have the “private key”.

At step 330, the consumer plug-in 14 initiates an SSL 128 bit connection to the STMS 30, so that SSL encryption becomes the third layer of encryption used as the FP block data is transmitted to the STMS 30 through the STMS firewall 34. The consumer plug-in 14 then waits for a specified amount of time for a response. The consumer is informed of the time frame involved in the transaction. At step 335, this portion of the process is complete.

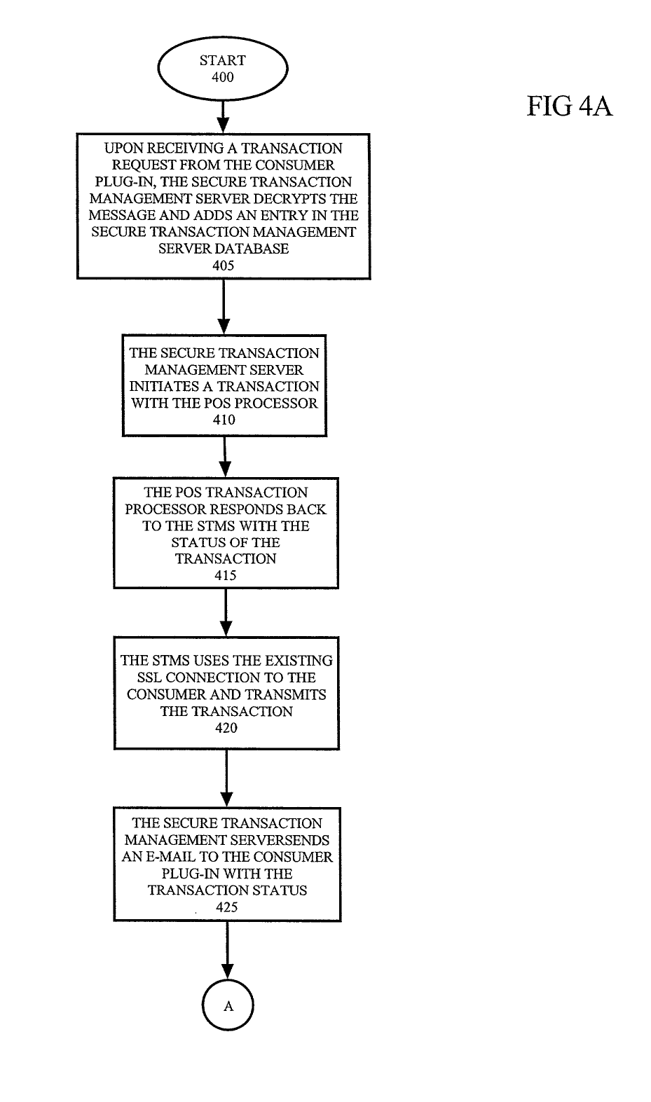

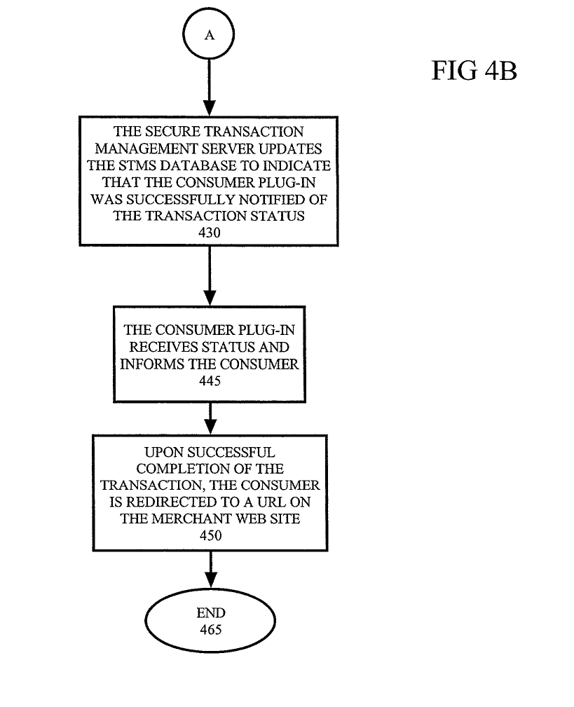

Steps 230 through 252 are described in greater detail in FIG. 4, the process of the STMS receiving and processing the transaction from the consumer. At step 400, the process is started. At step 405, the STMS 30 receives the transaction request sent by the consumer plug-in 14. The SSL is automatically decrypted by the STMS 30. The STMS 30 decrypts the public key/private key encryption and the STMS 30 creates an entry in the db STMS 36 with the transaction information and sets the transaction status to pending. At step 410, the STMS 30 initiates a transaction with the POS transaction processor 40 by transmitting the appropriate information.

At step 415, the POS transaction processor 40 responds back to the STMS 30 with the status of the transaction. Upon receiving a response from the POS transaction processor center, the STMS 30 updates the STMSdb server 35 which in turn updates the database 36 with the new status of the transaction. At step 420, the STMS 30 responds to the consumer plug-in 14 with the status of the transaction using the same SSL socket as before. At step 425, the STMS 30 sends e-mail to the consumer on computer 12 indicating the status of the transaction. At step 430, the STMS 30 updates the STMSdb server 35 which in turn updates the database 36 to indicate that the consumer plug-in 14 was successfully notified of the transaction status. At step 445, upon receiving status at step 425, the consumer plug-in 14 informs the consumer of the status. If the status is not successful, then the consumer will be provided with information on how to proceed. At step 450, upon successful completion of the transaction, the consumer is redirected to a Uniform Resource Locator (URL) on the merchant's web server 20. The URL was provided as a parameter on initial loading of the consumer plug-in 14. At step 465, the process is complete.

Consumer Software ( Consumer Plug-In)

The functionality of the consumer plug-in 14 is described below. The consumer plug-in 14 requires browser support. Due to the nature of the consumer plug-in 14 based plug-in that will be required, it will be necessary to require that consumers have one of the latest versions of Microsoft Internet Explorer (MSIE) or Netscape Navigator (NN). This requirement is due to the fact that older versions of Java were far too locked down and would not allow a Java applet to write data out to the keyboard device such as PIN/PAD 16. This is a necessity as the keypad that cards are swiped through requires at least an activation command.

In order for the consumer plug-in 14 to successfully make a transaction request, obtain status of an outstanding transaction request, and recover from any failed requests, the following minimum parameters are required: merchant number; merchant/consumer tracking number which is a number assigned by the merchant to track the consumer's order; the total dollar amount of the transaction; and follow-up URL which is a merchant web page that consumer plug-in 14 can redirect the consumer to upon successful completion of the transaction. These parameters are passed to the consumer plug-in 14 by the merchant server 20 upon loading the plug-in 14 into the consumer's browser.

The security and encryption used by the consumer plug-in 14 includes 128 bit SSL connections for any confidential information exchanges between the consumer plug-in 14 and STMS 30 merchant framework 22 and the consumer plug-in 14 uses the DES when working with any card or PIN information entered through the PIN/PAD 16, and RSA as an additional layer wrapped around the entire FP message block.

The consumer is provided access to help and information when performing online transactions that come directly from a customer's checking account. It will be natural for a consumer to have concerns and questions. Throughout the entire authorization process, the consumer plug-in 14 displays links to detailed information about each step. These links will summarize the security of the transactions, and provide the consumer with ways to get more detailed information if desired. The Specifications and Requirements of the STMS Portion 30, 32 The transaction database 36 that resides on the STMS database server 35 will contain detailed information about the valid merchants who may use STMS database server 35 for transactions. Some of this information is listed below. The fields, tables and indices in this database can be expanded.

Company name

Merchant number * Street address, city, state, zip code, country

Bank ID

Processor ID

Financial contact name, number(s), address

Technical contact name, number(s), address

Web site address

Special URL for merchant framework access.

Status—current, pending, revoked, etc.

Special notes and circumstances

SIC code

The transaction database will contain detailed entries of all transaction requests from beginning to end. Some of this information is listed below. Information that is required in order to initiate a transaction from the consumer plug-in it is indicated by an asterisk (*).

Transaction number assigned by STMS

Merchant number

Merchant tracking number assigned by merchant shopping cart system

Total dollar amount of the transaction

Consumer card number, possibly encrypted for added security

Status—new, pending, success, fail, invalid

Notes—error messages and/or logs by a operator

Time of initial entry and/or update of status field

Card type

Auth code

Reference#

PIN/PAD serial number

Path

The following additional entries are recommended for the sole purpose of tracking down possible hack attempts against the STMS system. This type of information is typically tracked and monitored by the firewall as well. Quality firewall software is configured to automatically block addresses when a possible hack is detected.

TCP/IP address of requesting system

Web browser type and version

Ethernet/MAC address from dedicated connections if available.

Hardware Overview

FIG. 11 is a block diagram illustrating an exemplary computer system 1100 upon which an embodiment of the invention may be implemented. The computer system 1100 can be used, for example. The present invention is usable with currently available personal computers, mini-mainframes and the like.

Computer system 1100 includes a bus 1102 or other communication mechanism for communicating information, and a processor 1104 coupled with the bus 1102 for processing information. Computer system 1100 also includes a main memory 1106, such as a random access memory (RAM) or other dynamic storage device, coupled to the bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to the bus 1102 for storing static information and instructions for the processor 1104. A storage device 1110, such as a magnetic disk or optical disk, is provided and coupled to the bus 1102 for storing information and instructions.

Computer system 1100 may be coupled via the bus 1102 to a display 1112, such as a cathode ray tube (CRT) or a flat panel display, for displaying information to a computer user. An input device 1114, including alphanumeric and other keys, is coupled to the bus 1102 for communicating information and command selections to the processor 1104. Another type of user input device is cursor control 1116, such as a mouse, a trackball, or cursor direction keys for communicating direction information and command selections to processor 1104 and for controlling cursor movement on the display 1 1 12. This input device typically has two degrees of freedom in two axes, a first axis (e.g., x) and a second axis (e.g.,) allowing the device to specify positions in a plane.

The invention is related to the use of a computer system 1100, such as the illustrated system, to display and process secure Internet payment transactions. According to one embodiment of the invention, the processing of secure Internet payment transactions is provided by computer system 1100 in response to processor 1104 executing sequences of instructions contained in main memory 1106. Such instructions may be read into main memory 1106 from another computer-readable medium, such as storage device 1110. However, the computer-readable medium is not limited to devices such as storage device 1 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 1106 causes the processor 1104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 1100 also includes a communication interface 1118 coupled to the bus 1102. Communication interface 1108 provides a two-way data communication as is known. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. In the preferred embodiment communication interface 1118 is coupled to a virtual blackboard. Wireless links may also be implemented. In any such implementation, communication interface 1118 sends and receives electrical, electromagnetic or optical signals which carry digital data streams representing various types of information. Of particular note, the communications through interface 1118 may permit transmission or receipt of the secure Internet payment transactions. For example, two or more computer systems 1100 may be networked together in a conventional manner with each using the communication interface 1118.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication services through the world wide packet data communication network now commonly referred to as the “Internet” 1128. Local network 1122 and Internet 1128 both use electrical, electromagnetic or optical signals which carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

FIG. 12 is similar to FIG. 1 in that it includes the security zone 10. Additionally in FIG. 12, there are two POS transaction processors A and B. Transaction processor A has an HSM 1212 and transaction processor B has an HSM 1214. Each of the transaction processors A and B shares keys with HSM 31 which is within security zone 10. There are a plurality of credit card associations and debit card networks including Visa 1220, MasterCard 1230, Star Network 1240, and NYCE 1250. It should be noted that Visa 1220 and MasterCard 1230 have no HSMs associated with them. The Star Network 1240 and the NYCE 1250 have associated HSMs 1242 and 1252, respectively. Star Network 1240 and NYCE 1250 are debit card processors and require pins whereas the credit card associations Visa 1220 and MasterCard 1230 do not require pins and therefore do not have HSMs associated with them. Additionally, there are two issuing banks A 1260 and issuing bank 1270 each having an associated HSM 1262 and 1272, respectively. Each of these HSMs shares keys with HSMs 1242 and HSM 1252.

It should also be noted that each of the transaction processors A and B can communicate with Visa 1220, MasterCard 1230, Star Network 1240 and NYCE 1250. Thus, a transaction can occur between any of the transaction processors and any of the credit card associations or debit card networks. The merchant 20 is associated with a transaction processor A or B and the consumer 12 having their credit card or debit card is associated with one of the issuing banks A or B. Further, depending on whether the credit card is a Visa or MasterCard or an American Express will control which the transaction processor deals with and similarly if the card is a debit card the consumer's debit card will control which of the debit card networks the transaction. Within security zone 10, as illustrated in FIG. 12, the transaction flow is exactly the same as illustrated and discussed with respect to FIG. 1. The additional transaction processor's credit card associations, debit networks and issuing banks are illustrated to indicate the use of the present invention in its overall environment.

When multiple processors are connected to the STMS 30, the HSM 31 can use a different key for each connection. This makes possible two important STMS features:

1) The STMS 30 can securely route transactions to multiple POS processors (e.g., Universal Payment Processing System (UPPS), First Data Corp. (FDC), National Data Corp. (NDC), etc.) using their encryption keys, while using just one key in the deployed PIN/PADs 16. This makes it possible for the present invention to take a transaction from any PIN/PAD 16 and route it to any processor connected to the STMS server 30. This is the exact same methodology that all processors, switches and networks use today to establish multiple secure connections to route transactions that include PIN blocks.

Transactions will be routed based on which processor (which financial institution) has the relationship with the merchant that the PIN pad user 16 is transacting with. Routing can be driven by an address loaded into the merchant web site and transmitted with each transaction and/or a database maintained at the STMS. For over 20 years, this same type of routing has been provided to POS processors by telecommunications providers such as Transaction Network Services, AT&T, Sprint and CompuServe, to route transactions from “dial-up” POS terminals to the correct POS processor.

2) The STMS 30 can implement “triple DES” over the security zone between the HSM 1200 and the PIN/PADs 16 even though no POS processors support triple DES today. The HSM 1200 can use triple DES over the zone to the PIN/PAD 16 and traditional single DES over the upstream zone(s). Triple DES uses a more complex algorithm than single DES to provide enhanced security for the PIN block.

It should now be apparent that a method and system for providing secure Internet payments using either a credit card or ATM card has been described.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1 A method of transacting a secure ATM transaction via the Internet, comprising:
browsing a merchant web site by a user;
initiating a secure payment transaction at the merchant web site prompting a consumer through the process of entering payment data;
creating an encrypted PIN block;
building an encrypted payment block at the consumer's Internet access device that includes the encrypted PIN block and the payment data enclosed in two or more layers of encryption and forwarding the encrypted payment block to a secure host without sending the encrypted payment block to the merchant web site;
decrypting the payment block at the secure host and routing the decrypted payment block to a payment processor to request authorization for the payment transaction; and
if the payment processor sends an authorization for the payment transaction, then forwarding the authorization to the consumer and the merchant.

2. The method of claim 1, wherein the encrypted PIN block is encrypted to a DES standard.

3. The method of claim 1, wherein the two or more layers of encryption is a public/private key encryption.

4. The method of claim 1, comprising sending an indication of the completion of the authorization to the user.

5. The method of claim 1, wherein said creating step is performed using a PIN/PAD.

6. The method of claim 1, comprising decrypting the encrypted payment block by the secure host into a PIN encrypted block.

7. The method of claim 6, comprising reformatting for transmission the DES encrypted payment block to the payment processor.

8. The method of claim 1, comprising building an HTML payment page including an encrypted MAC.

9. The method of claim 1, comprising combining the encrypted PIN block, a card data, a dollar amount, a merchant 10 and a MAC to form the encrypted payment block.

10. The method of claim 1, wherein one layer of encryption using DES, a second layer is RSA encryption and a third layer of encryption is 128-bit SSL.

11. The method of claim 10, comprising said decrypting step includes removing the SSL and RSA layers.

12. The method of claim 11, comprising verifying that the payment block has not been altered.

13. The method of claim 8, comprising decrypting the MAC and comparing the decrypted MAC against data elements in the encrypted payment block.

14. The method of claim 1, wherein said forwarding step comprises encrypting a MAC and adding it to the authorization response message sent by the secure host.

15. The method of claim 14, comprising displaying an authorization message to a user and forwarding the authorization including the encrypted MAC to the merchant web site.

16. The method of claim 15, comprising using the MAC to verify that the dollar amount and the authorization message has not been altered between a merchant web site and the secure host.

17. A method of transacting a secure credit card payment transaction via the Internet, comprising:
browsing a merchant web site by a user;
initiating a secure payment transaction at the merchant web site prompting a consumer through the process of entering payment data;
entering a credit card number;
building an encrypted payment block at the consumer's Internet access device that includes the credit card number and the enclosed three or more layers of encryption and forwarding the encrypted payment block to a secure host without sending the encrypted payment block to the merchant web site;
decrypting the payment block at the secure host and routing the decrypted payment block to a payment processor to request authorization for the payment transaction; and
if the payment processor sends an authorization for the payment transaction, then forwarding the authorization to the consumer and the merchant.

18. The method of claim 17, wherein the further encryption is a public/private key encryption.

19. The method of claim 17, comprising sending an indication of the completion of the authorization to the user.

20. The method of claim 17, comprising building an HTML payment page including an encrypted MAC.

21. The method of claim 17, comprising combining a card data, a dollar amount, a merchant ID and MAC to form the encrypted payment block.

22. The method of claim 17, wherein one layer of encryption using DES, a second layer is RSA encryption and a third layer of encryption is 128-bit SSL.

23. The method of claim 22, comprising said decrypting step includes removing the SSL and RSA layers.

24. The method of claim 23, comprising verifying that the payment block has not been altered.

25. The method of claim 17, comprising decrypting the MAC and comparing the decrypted MAC against data elements in the encrypted payment block.

26. The method of claim 17, wherein said forwarding step comprises encrypting a MAC into the authorization.

27. The method of claim 26, comprising displaying an authorization message to a user and forwarding the authorization including the encrypted MAC to the merchant web site.

28. A system for transacting a secure transaction via the Internet, comprising:
a PIN/PAD operatively connected to said consumer Internet access device for entering a consumer PIN and creating an encrypted PIN block;
a consumer Internet access device having a consumer software plug-in associated with a web browser residing thereon for building an order including the encrypted PIN block and transaction data enclosed in two or more layers of encryption to form an encrypted payment block;
a merchant server having a merchant response software residing thereon for building an encrypted HTM payment page including an encrypted MAC; and
lo a secure transaction management server having software residing thereon and a hardware security module for decrypting the encrypted payment block to be forwarded to a payment processor.

29. The system of claim 28, wherein said consumer software plug-in combines the encrypted PIN block, a card data, a dollar amount, a merchant 10 and MAC to form the encrypted payment block.

30. The system of claim 28, wherein one layer of encryption using DES, a second layer is RSA encryption and a third layer of encryption is 128-bit SSL.
